(19) United States
(12) Patent Application Publication
(10) Pub. No.: US 2022/0108382 A1
(43) Pub. Date: Apr. 7, 2022

(54) ELECTRONIC GIFTING

(71) Applicant: Polemur Limited, London (GB)

(72) Inventor: Kirill Chliaifchtein, London (GB)

(21) Appl. No.: 17/496,736

(22) Filed: Oct. 7, 2021

Related U.S. Application Data
(60) Provisional application No. 63/088,991, filed on Oct. 7, 2020.

(51) Int. Cl. G06Q 30/06

(52) U.S. Cl. CPC G06Q 30/0641

(57) ABSTRACT

Methods, systems, and apparatus, including computer programs encoded on computer storage media for electronic-based gifting. The system generates a first user interface for receiving information about a customer. The system generates a second user interface for receiving information about a recipient's address. The system generates a third user interface and generates a gift link url address. The system presents via the third user interface the gift link url address. The third user interface provides a copy function to allow the customer user to copy the gift link url address. The gift link is intended to be sent to a recipient via a communications application such as SMS text or other messaging application. The system generates a fourth user interface based on the recipient opening the gift link url. The system receives customization input for a gift via the fourth user interface by the customer. The system receives a delivery address for the customer of where the gift is to be sent. After receiving the customization input for the gift, and the delivery address, the system sends a notification to the customer that the recipient has accepted the gift. The system generates a fifth user interface where the customer may input payment information and complete the delivery of the gift to the recipient.

### CROSS-REFERENCE TO RELATED APPLICATIONS

This application claims the benefit of U.S. Provisional Application No. 63/088,991, filed Oct. 7, 2020, which is hereby incorporated by reference in its entirety.

### BACKGROUND

The disclosure relates to gifting.

### SUMMARY

Described herein is an innovative system and methods directed toward gifting. Methods, systems, and apparatus, including computer programs encoded on computer storage media for electronic-based gifting. The system generates a first user interface for receiving information about a customer. The system generates a second user interface for receiving information about a recipient's address. The system generates a third user interface and generates a gift link url address. The system presents via the third user interface the gift link url address. The third user interface provides a copy function to allow the customer user to copy the gift link url address. The gift link is intended to be sent to a recipient via a communications application such as SMS text or other messaging application. The system generates a fourth user interface based on the recipient opening the gift link url. The system receives customization input for a gift via the fourth user interface by the customer. The system receives a delivery address for the customer of where the gift is to be sent. After receiving the customization input for the gift, and the delivery address, the system sends a notification to the customer that the recipient has accepted the gift. The system generates a fifth user interface where the customer may input payment information and complete the delivery of the gift to the recipient.

The system provides seamless online gifting experience which is faster (no address or payment steps to send item), more personalised (can attach message with gift) and more engaging/fun.

The system provides impulsive gifting: can send anything with a few clicks and no worries about needing address. If its a work colleague or a social media acquaintance you can seamlessly send them a physical gift without intrusion or asking for their address etc.

The system provides for last minute gifting: because virtual gift notification is instant, customers can really shop “last minute”. Even if someone's birthday is already today its not too late—customer can buy and send a gift right now to be received (virtually) right now.

The system provides for reduced hesitation when gifting as Recipient will be able to exchange/modify your gift selection to suit their needs.

The system provides for reduced returns/refunds (due to step above).

The system provides for insights and data on the gifting cohort (previously unavailable)

Even in the “normal” gifting process where customer manually inputs the address of their Recipient, the system's ability to send an instant “Gift Notification” adds richness and the ability for an “instant” gift.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 illustrates an exemplary embodiment of the system.

FIG. 2 illustrates an exemplary embodiment of the system.

FIG. 3 illustrates an exemplary embodiment of the system.

FIG. 4 illustrates an exemplary embodiment of the system.

FIG. 5 illustrates an exemplary embodiment of the system.

FIG. 6 illustrates an exemplary embodiment of the system.

FIG. 7 illustrates an exemplary embodiment of the system.

FIG. 8 illustrates an exemplary embodiment of the system.

FIG. 9 illustrates an exemplary embodiment of the system.

FIG. 10 illustrates a diagram of an exemplary environment in which some embodiments may operate.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The system provides for various functionality.

The system provides seamless online gifting functionality as a SaaS solution for e-commerce websites.

The system allows customer to send any site product (or multi-basket of products) to their desired gift recipient: with just a few clicks skipping checkout entirely; a recipient gets the virtual gift instantly; a customer does not need to know color/size/gift preference, a customer does not need recipient's delivery address.

The system may send gifts without knowing a recipient's delivery address.

The system may send gifts with reduced number of steps (product page→send link) meaning you can send an e-gift without needing to go through address and payment steps.

The system may send to gift “last minute”—the system provides truly “instant” gifting. If I send you a gift link now, you receive it now. The sender gets to see that you have been gifted instantly!

The system provides for a recipient to choose convenient time and place for their delivery to take place.

The system provides for a recipient to modify/customize their gift (size/color etc) or change it for another altogether. For the sender this also increases confidence when shopping.

The system provides for significant reduction in returns (because Recipient can customize their gift before it is dispatched hence no need to return it for different size afterwards)

The system may include logic to present only items/modifications reflecting real time inventory levels of website (not the level that was there at original send time), and special logic for suggesting alternatives in the event that the original item is out of stock

In the case that Customer knows the address, the system's “Gift Notification” functionality still allows the “instant/last minute” virtual gift delivery even if item arrives later

The system provides for analytics and insights into gifting behaviour on site (without the system's websites are not able to extract gifting as a separate cohort from their overall site revenue or behaviour).

The system adds a “Send as Gift” button to product pages of an e-com site. This is an Entry Point into the system flow described below (hosted by the system but may be white-labelled so customer feels like they are on the original website).

Exemplary Process Flow

Referring to FIG. 1 which illustrates an exemplary embodiment of the system. As depicted in the system generated user interface, in a first step of operations, a customer provides some details about themselves, and adds notes for a recipient.

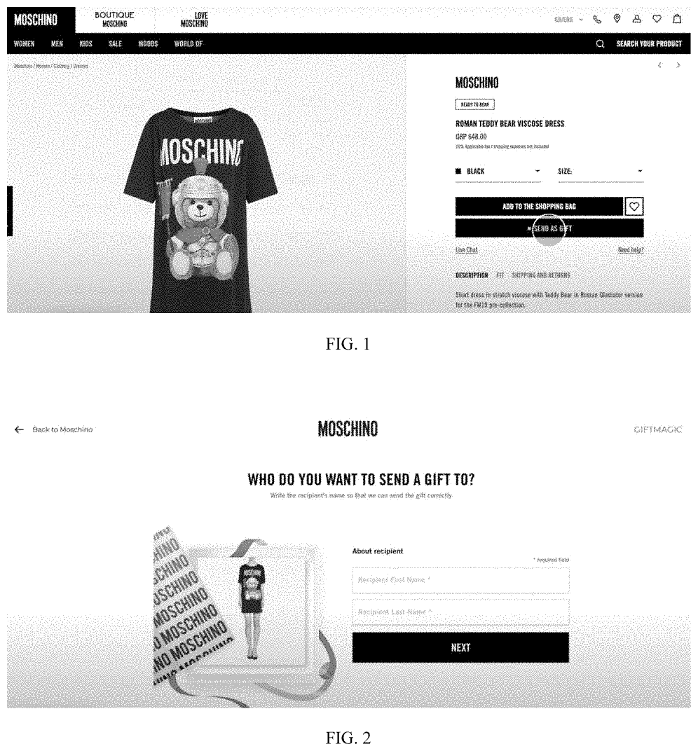

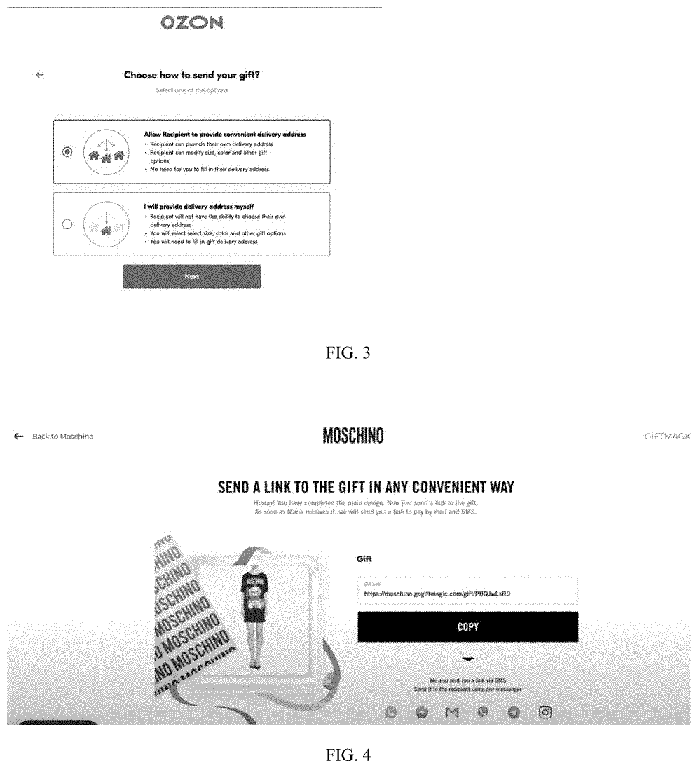

Referring to FIG. 2 which illustrates an exemplary embodiment of the system. As depicted in the system generated user interface, in a first second step of operations, the system provides for the customer to choose between two options—A or B as depicted in the system generated user interface of FIG. 3. (Option A) “I don't know Recipient's address” (send as e-gift), and option B) “I know Recipient's address” (input address manually)).

Referring to FIG. 4 which illustrates an exemplary embodiment of the system. As depicted in the system generated user interface, in a first process flow where the system allows the recipient to provide convenient delivery address. The system generates and provides a user interface where the customer is presented with “gift link” (a url). The customer shares this “gift link” with desired recipient (by sending it in any chat e.g. messenger, email, text message, etc).

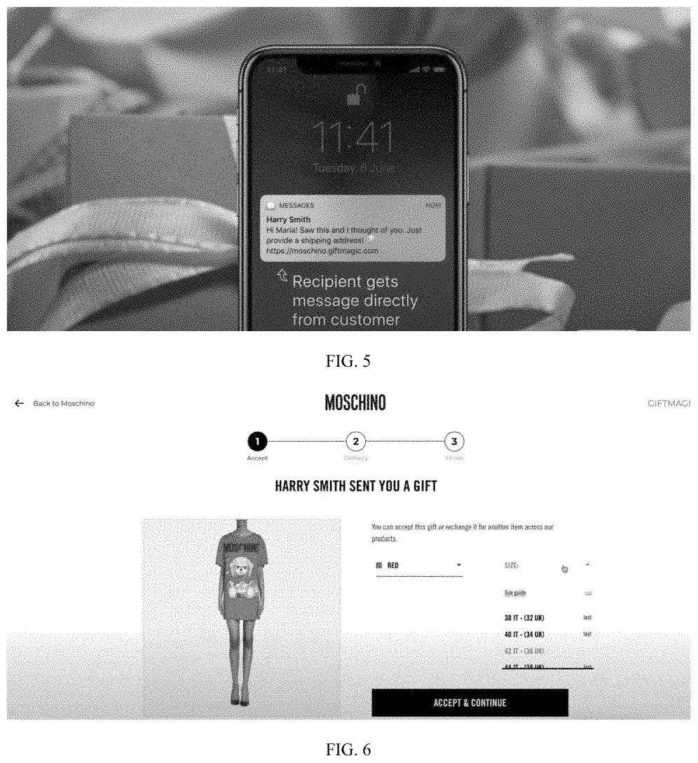

Referring to FIG. 5 which illustrates an exemplary embodiment of the system. A recipient receives the “gift link” in the respective application (e.g., messenger, email, text message, etc.) A recipient opens “gift link” to reveal gift item.

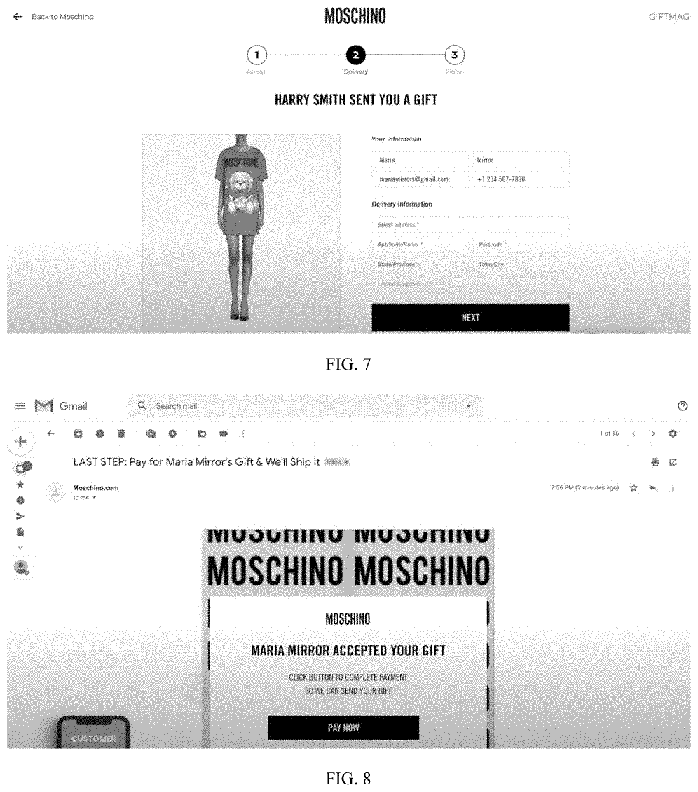

Referring to FIG. 6 which illustrates an exemplary embodiment of a user interface of the system. When the system clicks on the “gift link”, the link opens up a system generated user interface as depicted in FIG. 6. The system generated user interface allows the recipient to customise the item (size/color/etc.) or may exchange the item for other suggested items.

Referring to FIG. 7 which illustrates an exemplary embodiment of a user interface of the system. The recipient may then enter in delivery information (such as a delivery address) via the system generated user interface as depicted in FIG. 7.

Referring to FIG. 8 which illustrates an exemplary embodiment of a notification generated by the system. After successful performance of the recipient steps above (=“Gift Accepted”), the system notifies the customer and sends the customer a link to complete payment. The notification can be an e-mail, or other electronic notification.

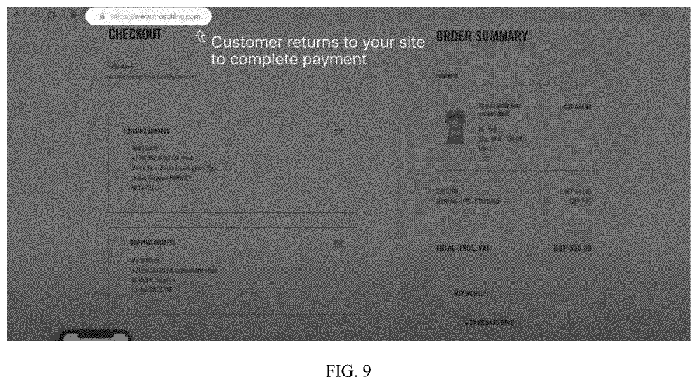

Referring to FIG. 9 which illustrates an exemplary embodiment of a user interface of the system. The customer proceeds to the Checkout page of the e-commerce website to complete payment. The gift is then dispatched directly to the recipient based on the recipient address received by the system.

In an alternative process for the address, for Option B) as to FIG. 3B, where the Customer “I will provide delivery address myself”. The user interface receives an input of the delivery address, and proceeds to make payment. The system notifies customer that they can send a “Notification Card” to their Recipient (this is a url link). The customer may send this link to recipient using any messenger. “Notification card” shows the item and estimated delivery date (but unlike “gift link” there is no ability to modify the product—this link is just for notification purposes).

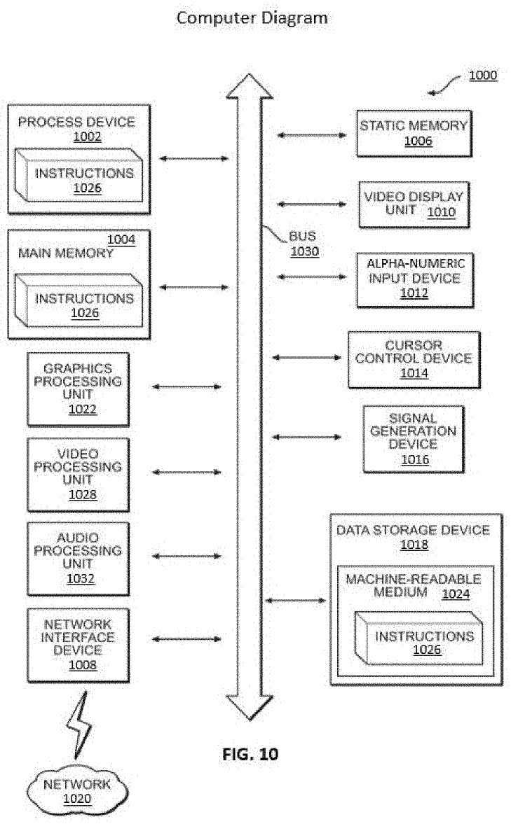

FIG. 10 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a static memory 1006 (e.g., flash memory, static random access memory (SRAM), etc.), and a data storage device 1018, which communicate with each other via a bus 1030.

Processing device 1002 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 is configured to execute instructions 826 for performing the operations and steps discussed herein.

The computer system 1000 may further include a network interface device 1008 to communicate over the network 1020. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), a graphics processing unit 1022, a signal generation device 1016 (e.g., a speaker), graphics processing unit 1022, video processing unit 1028, and audio processing unit 1032.

The data storage device 1018 may include a machine-readable storage medium 1024 (also known as a computer-readable medium) on which is stored one or more sets of instructions or software 1026 embodying any one or more of the methodologies or functions described herein. The instructions 1026 may also reside, completely or at least partially, within the main memory 1004 and/or within the processing device 1002 during execution thereof by the computer system 1000, the main memory 1004 and the processing device 1002 also constituting machine-readable storage media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A system comprising one or more processors, and a non-transitory computer-readable medium including one or more sequences of instructions that, when executed by the one or more processors, cause the system to perform operations comprising:
generating a first user interface;
receiving, via the first user interface, information about a customer;
generating a second user interface;
receiving, via the second user interface, information about a recipient's address;
generating a third user interface;
generating a gift link url address, and presenting the gift link url address via the third user interface;
providing a copy function to allow a user to copy the gift link url address via the third user interface, the gift link intended to be sent to a recipient;
generating a fourth user interface based on the recipient opening the gift link url;
receiving a customization input for a gift via the fourth user interface by the customer;
receiving a delivery address for the customer of where the gift is to be sent;
after receiving the customization input for the gift, and the delivery address, sending a notification to the customer that the recipient has accepted the gift;
generating a fifth user interface; and
receiving payment information by the customer, and completing the deliver of the gift to the recipient.

2. A computer-implemented method comprising the operations of:
generating a first user interface;
receiving, via the first user interface, information about a customer;
generating a second user interface;
receiving, via the second user interface, information about a recipient's address;
generating a third user interface;
generating a gift link url address, and presenting the gift link url address via the third user interface;
providing a copy function to allow a user to copy the gift link url address via the third user interface, the gift link intended to be sent to a recipient;
generating a fourth user interface based on the recipient opening the gift link url;
receiving a customization input for a gift via the fourth user interface by the customer;
receiving a delivery address for the customer of where the gift is to be sent;
after receiving the customization input for the gift, and the delivery address, sending a notification to the customer that the recipient has accepted the gift;
generating a fifth user interface; and
receiving payment information by the customer, and completing the deliver of the gift to the recipient.

3. A computer program product comprising a non-transitory computer-readable medium having a computer-readable program code embodied therein to be executed by one or more processors, the program code including instructions to perform the operations of:
generating a first user interface;
receiving, via the first user interface, information about a customer;
generating a second user interface;
receiving, via the second user interface, information about a recipient's address;
generating a third user interface;
generating a gift link url address, and presenting the gift link url address via the third user interface;
providing a copy function to allow a user to copy the gift link url address via the third user interface, the gift link intended to be sent to a recipient;
generating a fourth user interface based on the recipient opening the gift link url;
receiving a customization input for a gift via the fourth user interface by the customer;
receiving a delivery address for the customer of where the gift is to be sent;
after receiving the customization input for the gift, and the delivery address, sending a notification to the customer that the recipient has accepted the gift;
generating a fifth user interface;
receiving payment information by the customer, and completing the deliver of the gift to the recipient.
